(19) United States
(12) Patent Application Publication
(10) Pub. No.: US 2005/0003139 A1
(43) Pub. Date: Jan. 6, 2005

(54) Loop pile fabric having randomly arranged loops of variable height

(75) Inventor: Michael A. Keller, Simpsonville, SC (US)

Correspondence Address: Jeffery E. Bacon;Legal Department, M-495, PO Box 1926, Spartanburg, SC, 29304, US

(73) Assignee: Milliken & Company

(21) Appl. No.: 10/835,772

(22) Filed: Apr. 30, 2004

Related U.S. Application Data
(63) Continuation-in-part of application No. 10/613,240, filed on Jul. 3, 2003.
(63) Continuation-in-part of application No. 10/613,241, filed on Jul. 3, 2003.

(51) Int. Cl. B32B 33/00

(52) U.S. Cl. 428/89; 428/92; 428/97; 66/194; 28/159

(57) ABSTRACT

A loop pile fabric wherein the pile portion has a first group of yarn loops projecting outwardly from the base portion to a first height and at least a second group of yarn loops projecting outwardly from the base portion to a second height lower than the first height. At least a portion of the first group of yarn loops and at least a portion of the second group of yarn loops are formed from segments of a common yarn. In the fabric the segments of the common yarn forming the second group of yarn loops are formed from yarn filaments having an average cross sectional area which is greater than the average cross sectional area of yarn filaments in the segments of the common yarn forming the first group of yarn loops.

### CROSS-REFERENCE TO RELATED APPLICATIONS

This application is a continuation-in-part of prior copending U.S. application Ser. No. 10/613,240, filed Jul. 3, 2003 entitled Pile Fabric and Heat Modified Fiber and Related Manufacturing Process and a continuation-in-part of prior copending U.S. application Ser. No. 10/613,241 filed Jul. 3, 2003 entitled Method of Making Pile Fabric the contents of all of which are incorporated by reference herein in their entirety.

### TECHNICAL FIELD

The present invention relates generally to loop pile fabrics having an upstanding pile surface and more particularly to loop pile fabrics having a first group of pile-forming loops of a first height and at least a second group of pile-forming loops of a second shorter height. A method of forming the fabric is also provided.

### BACKGROUND OF THE INVENTION

Loop pile fabrics are generally known. Such fabrics may be formed by techniques such as knitting a pile yarn in combination with a ground yarn using techniques such as POL knitting, Tricot knitting and Raschel knitting and the like as will be well known to those of skill in the art. Such fabrics may also be formed by other techniques such as tufting and stitch bonding as will also be well known to those of skill in the art. The result of all such processes is the formation of a fabric having a base with an arrangement of upstanding outwardly projecting loops.

If desired, a degree of variability may be introduced across the fabric by the introduction of defined patterns of loops projecting outwardly from the surface. However, such patterns which are introduced as the result of adjustment of machine settings provide a substantially regular pattern of loops and voids across the surface of the fabric. These regular patterns may be discernible upon visual inspection of the fabric thus failing to provide the appearance of random occurrence. In addition, little if any benefit is provided from the portions of pile-forming yarn located within the voids since such yarns are embedded within the ground and thus may not substantially aid in providing a textured feel to the fabric.

In the past, loop pile fabrics have been formed from fully drawn multi-filament yarns wherein the yarns are drawn and heatset under tension so as to extend and orient the individual filaments. In such a process each of filaments in the yarn is subjected to a substantially uniform heating and extension treatment such that the yarn will thereafter act in a uniform manner upon post fabric formation treatments such as heat setting, dyeing and the like. That is, since the yarn has been uniformly treated it does not exhibit variable response characteristics when subjected to heating or other treatment conditions.

It is also known to form cut pile fabrics from yarns which are subjected to a substantially uniform heat treatment during drawing but which are not fully drawn. Such a process is illustrated and described in U.S. Pat. No. 5,983,470 to Goineau the contents of which are incorporated herein by reference in their entirety. The resultant fabric has a generally striated appearance upon dyeing.

### SUMMARY OF THE INVENTION

According to one aspect, the present invention provides advantages and alternatives over the known art by providing a loop pile fabric formed from a pile yarn wherein the pile yarn has variable shrink characteristics at different zones along its length such that when the pile-forming yarn is introduced into a loop pile fabric and is thereafter subjected to heated finishing treatments, discrete portions of the yarn shrink towards the base of the fabric. The shrinking of zones along the pile-forming yarn towards the fabric base yields substantially random arrangements of unshrunken high pile loops in combination with shrunken lower pile loop zones of self textured crimped filaments with reduced crystalline orientation in the same yarn. The resultant fabric has an irregular pebble appearance.

### BRIEF DESCRIPTION OF THE DRAWINGS

The present invention will now be described by way of example only, with reference to the accompanying drawings which constitute a portion of the specification herein and wherein:

FIG. 1 illustrates a cut-away cross-section of a typical prior art loop pile fabric;

FIG. 2 illustrates schematically a practice for hot drawing a pile-forming yarn to impart variable shrink characteristics at zones along the length of such yarn;

FIG. 3 is a block diagram setting forth steps for forming a variable loop height fabric;

FIG. 4 illustrates a partially oriented non-textured multi-filament yarn prior to hot drawing;

FIG. 5 is a graphical representation illustrating the cross-sectional profile of yarn filaments at different zones along the length of the yarn of FIG. 4 during hot drawing;

FIG. 6 is a photomicrograph of a circular knit sock illustrating variable shrinkage segments of a formation yarn;

FIGS. 7A and 7B are x-ray diffraction patterns for high shrink and low shrink portions of a formation yarn respectively;

FIGS. 8A and 8B are angular distribution plots of selected diffraction peaks for high shrink and low shrink portions of a formation yarn respectively;

FIG. 9 illustrates a loop pile fabric incorporating the pile-forming yarn following hot drawing and post formation heat treatment wherein zones of the pile-forming yarn have undergone shrinkage towards the base of the fabric;

FIG. 10 is a photomicrograph of an exemplary loop-pile fabric according to the present invention incorporating high loops of unshrunken character and lower loops which have undergone heat shrinking;

FIG. 11 is a photomicrograph of loop fiber cross-sections in the tall loops of a fabric according to the present invention; and

FIG. 11A is a photomicrograph of loop fiber cross-sections in the heat-shrunk shorter loops in a fabric according to the present invention at the same magnification as FIG. 11.

While the present invention has been generally described above and will hereinafter be described in greater detail in relation to certain illustrated and potentially preferred embodiments, procedures and practices it is to be understood that in no event is the invention to be limited to such illustrated and described embodiments, procedures and practices. Rather, it is intended that the invention shall extend to all embodiments, practices and procedures as may be embodied within the broad principles of the invention.

### DESCRIPTION OF THE PREFERRED EMBODIMENTS

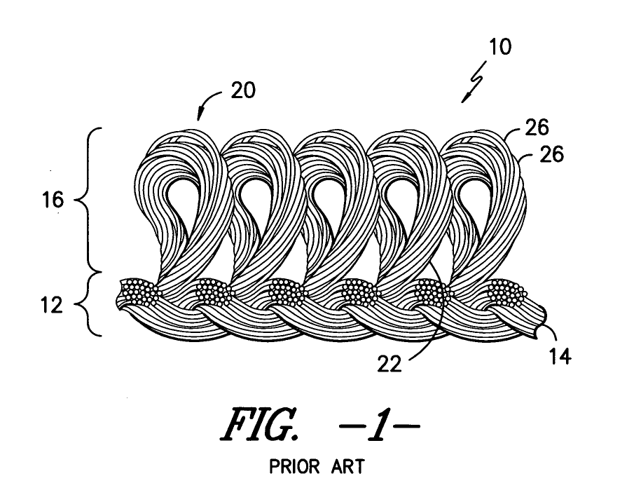

Reference will now be made to the various figures wherein, to the extent possible, like elements are designated by like reference numerals throughout the various views. In FIG. 1 there is illustrated a typical prior art loop pile fabric 10 such as may be formed in a warp knit construction as will be well known to those of skill in the art. As shown, the loop pile fabric 10 has a base or a ground portion 12 formed from ground yarns 14. The pile fabric 10 also includes a pile portion 16 made up of a multiplicity of loops 20 formed from pile yarns 22 knitted in conjunction with the ground yarns 14. As illustrated, the pile yarns 22 are made up of multiple discrete filaments 26. The pile yarns 22 in such prior art pile fabrics have typically undergone a hot drawing operation so as to impart a uniform heat treatment and extension to the filaments 26 prior to formation into the fabric 10. By way of example only, according to one typical process the pile yarns 22 are fully drawn to approximately 1.7 times their initial length while being subjected to a temperature of about 200° C. prior to formation into a fabric construction. This drawing and heat treatment imparts enhanced crystallite orientation to the yarn while also providing a substantially uniform heat history such that the propensity to undergo shrinkage is minimized and any shrinkage which does occur after the yarn is formed into a fabric will be substantially uniform. Thus, the pile yarns 22 yield loops 20 which are of substantially uniform character upon initial formation and which react in substantially the same manner when subjected to post-formation heat treatment such that uniform height characteristics and filament alignment are maintained after the fabric is heat set and dyed.

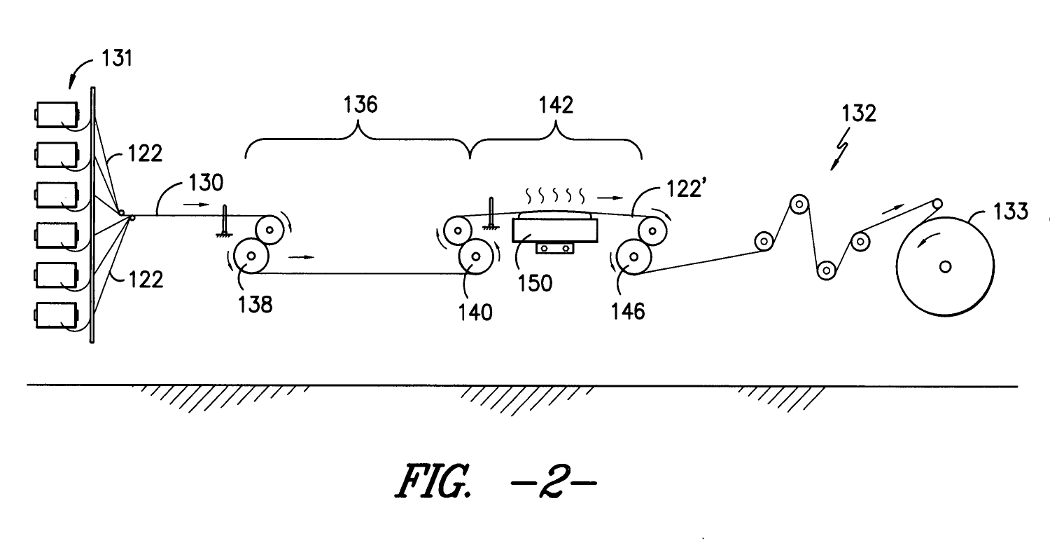

Referring to FIG. 2, according to a potentially preferred practice of the present invention a yarn sheet 130 formed from a plurality of yarns 122 is passed from a creel 131 through a drawing apparatus 132 to a take-up 133. The yarns 122 are so called “partially oriented yarns” of multi-filament construction wherein the filaments 126 (FIG. 4) have been interlaced at discrete zones along the length of the yarn. In practice it is contemplated that the yarns are formed from a heat shrinkable material, such as a thermoplastic. By way of example only and not limitation, exemplary fiber materials may include polyester, polypropylene, nylon and combinations thereof. As will be appreciated, when such materials are extruded from a melt solution into elongated filaments, those filaments have an intrinsic finite shrinkage potential which is activated upon subsequent heat exposure. During heat exposure shrinkage will proceed until the shrinkage potential is exhausted or the heating is terminated.

As shown, the drawing apparatus 132 has a first draw zone 136 located between tensioning rolls 138, 140 and a second draw zone 142 located between tensioning rolls 140 and 146. A contact heating plate 150 as will be well known to those of skill in the art engages the yarns 122 within the second draw zone 142. According to the potentially preferred practice, the partially oriented yarns 122 are passed through the first draw zone 136 with substantially no heating or drawing treatment. Thus, the yarns 122 are substantially unaltered upon entering the second draw zone 142. At the second draw zone the yarns 122 preferably undergo a relatively slight drawing elongation while simultaneously being subjected to a relatively low temperature heating procedure from the contact heater 150. Since the resultant yarn 122′ is not drawn to a condition of full orientation it is referred to as “underdrawn” yarn.

According to the potentially preferred practice the yarn is conveyed across the contact heater 150 at a high rate of speed such that the yarn does not reach a state of temperature equilibrium within the cross-section of the yarn at all segments. By way of example only, and not limitation, for a 115 denier polyester yarn it has been found that subjecting such yarn to a draw ratio of about 1.15 (i.e. 15% elongation) with a contact heater temperature of about 170 C to about 200 C with a take up speed of about 500-600 yards per minute provides the desired non-uniform cross-sectional heat treatment at some segments of the yarn while yielding a uniform cross-sectional heat treatment at other segments. Of course, the level of drawing, temperature and speed may be adjusted for different yarns.

The resultant yarn 122′ may then be formed into a fabric and heat treated to provide desired surface characteristics in the manner as will be described further hereinafter. Of course, it is also contemplated that the yarn 122′ may be subjected to heat treatment prior to introduction into a fabric if desired. In either case, discrete segments of the yarn 122′ undergo shrinkage and self-texturing while other segments along the same yarn experience little if any change.

The mechanism believed to be responsible for the non-uniform character of the yarns is believed to relate to the nature of the partially oriented yarn 122 being processed as well as the process conditions. Referring to FIG. 4, a representative illustration is provided of a partially oriented yarn (POY) 122 such as may be treated according to the practice described above. As illustrated, the yarn 122 of partially oriented construction is characterized by loose zones 151 in which the individual filaments 126 are disposed in generally aligned loose orientation relative to one another. These loose zones 151 are interspersed by discrete interlace nodes 152 in which the filaments are interlaced in a more compacted relation so as to hold the overall yarn 122 together. The cross-sectional heat transfer characteristics of the loose zones 151 are believed to be substantially different from that of the interlace nodes 152 and the yarn portions immediately adjacent such nodes.

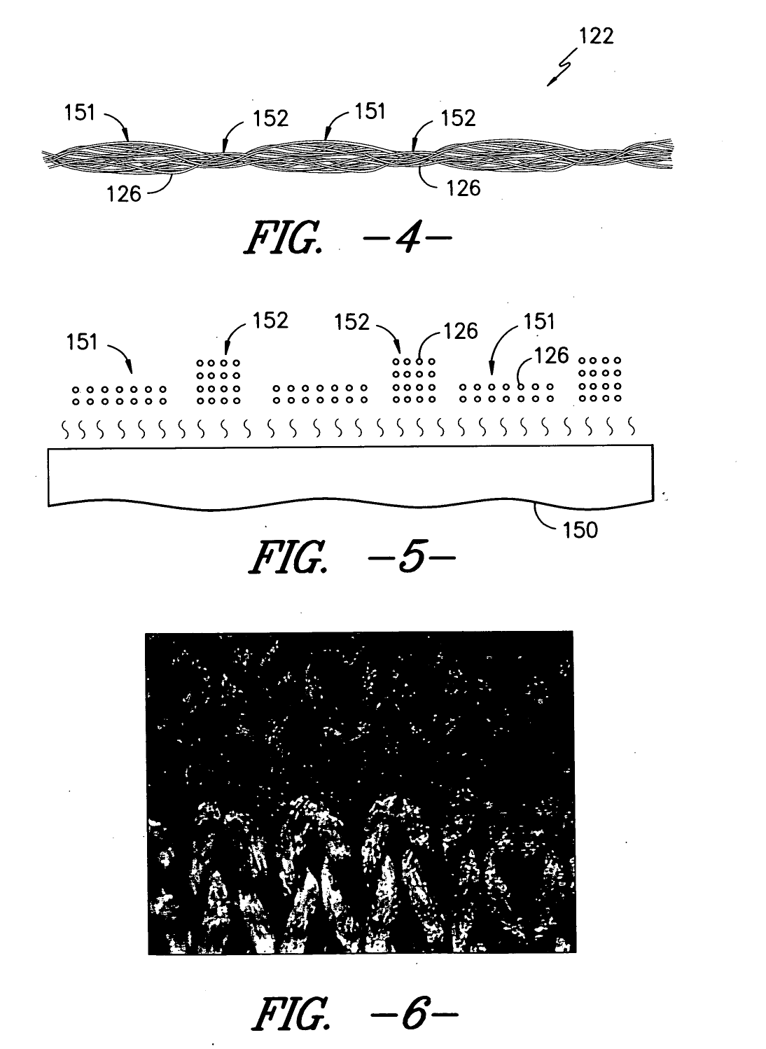

In FIG. 5 a graphical illustration of the fiber cross-section is provided showing the relative response of the filaments 126 in the loose zones 151 and interlace nodes 152 of the yarn during heating under slight draw conditions as described above. In particular, what is seen is that the filaments within the loose zones 151 are pulled towards the heater by a combination of tensioning and heat shrinkage so as to assume a relatively low cross-sectional profile orientation across the contact heater 150. This low cross-sectional profile allows those zones to receive a substantially uniform and complete heat treatment despite the high speed of travel across the heater. Conversely, the relatively slight degree of draw applied is inadequate to pull out the interlace nodes 152. Thus, flattening and spreading of the filaments at the interlace nodes is avoided. Thus, upon high speed underdrawing conditions the yarn portions around the interlace nodes 152 retain a higher more concentrated profile across the heater 150 rather than flattening out like the loose zones 151.

It is surmised that due to the lack of flattening and the high rate of travel across the heater, heat treatment is not uniform within the interlace nodes and adjacent portions. Thus, the filaments at those areas retain a relatively high level of shrinkage potential since a steady state temperature is not reached. The retention of such shrinkage potential leaves such zones susceptible to subsequent enhanced heat shrinkage relative to the remaining portions of the yarn (which have been subjected to uniform temperature treatment) upon subsequent heat application.

Variable Shrinkage and Bulking Evaluation:

The enhanced retained shrinkage potential of the yarn at the interlace nodes relative to the intermediate loose zones following the treatment process as outlined above has been confirmed by cutting out segments of an exemplary 260 denier polyester yarn treated according to the procedure outlined above and thereafter subjecting those cut out segments to a uniform heat treatment and then measuring the level of shrinkage caused by the heat treatment. In particular, a first group of two yarn segments was cut out from sections between interlace nodes such that each of the two cut out yarn segments in this first group was substantially devoid of any interlace node. A second group of three yarn segments was cut out from the yarn such that each of the three cut out yarn segments in this second group was formed substantially of a single interlace node. Both the first group and the second group of yarn segments were then subjected to a high temperature superheated steam treatment to observe shrinkage. The results are set forth in Table I below showing that the second group of yarn segments formed from the interlace nodes exhibited substantially increased shrinkage on a percentage basis relative to the yarn segments in the first group devoid of interlace nodes.

TABLE I

| | Percent Shrinkage |
|---|---|
| Sample Segment | After Heat Treating |
| Sample 1 - Interlace Node Segment | 43% |
| Sample 2 - Interlace Node Segment | 40% |
| Sample 3 - Interlace Node Segment | 33% |
| Sample 4 - No Interlace Nodes | 10% |
| Sample 5 - No Interlace Nodes | 0% |

In addition to shrinkage, it was also observed that the yarn segments formed from the interlace nodes underwent an enhanced degree of bulking and self texturing resulting in substantial filament thickening.

Crystalline Orientation:

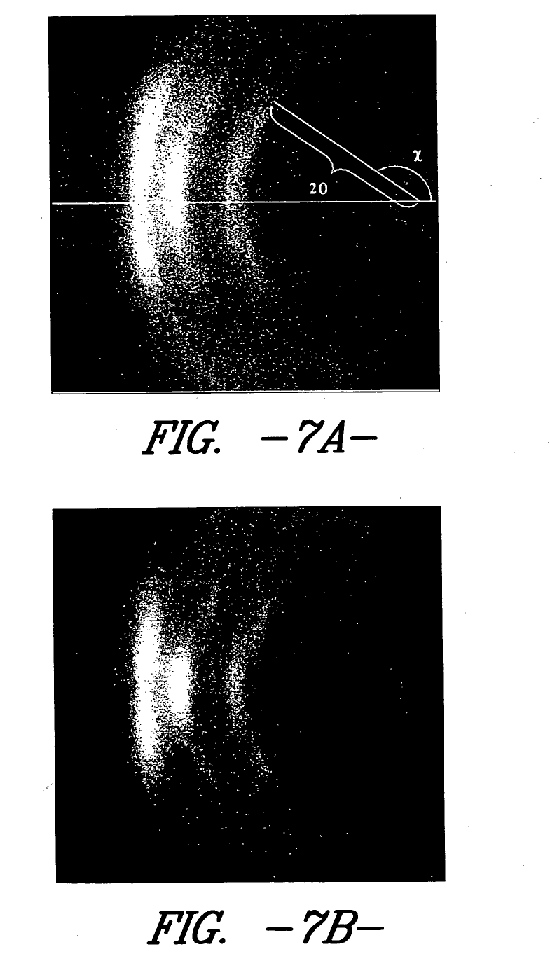

It has also been found that after heat treatment (such as occurs in fabric finishing) segments of the same yarn treated according to the procedures as previously described are characterized by substantially different levels of orientation as measured by wide angle x-ray diffraction. In order to characterize the molecular structure of the two different types of domains in a finished construction, a polyester yarn treated according to the process as illustrated and described in relation to FIG. 2 was circularly knitted into a sock (i.e. a tube), dyed, and finished. The finished sock exhibited two distinct types of courses: open courses consisting of yarn that had low shrinkage during finishing, and tight courses consisting of yarn that had high shrinkage during finishing. FIG. 6 illustrates a zone in the sock containing these two regions. Importantly, it is to be understood that the same yarn is used throughout the sock and that the different zones emerged only after subsequent heat treatment.

To understand the orientation differences in the zones of the sock individual courses of each type of region were removed from the construction for x-ray measurement. Courses were ‘double-folded’ to form a 4-ply yarn so as to increase the scattering signal rate and reduce the necessary exposure time. Samples were mounted onto standard x-ray sample mounts.

Wide-angle diffraction patterns were generated via exposure to x-rays generated with a rotating copper anode source having a primary wavelength of 1.5418 Å. Patterns were recorded using a general area detector system offset to an angle of 2θ=16.5° and set 15 cm from the sample position. Samples were oriented in the beam such that the fiber axis was vertical. Exposures of 15 minutes were used to generate patterns, and a background pattern acquired over an empty position on the sample holder was subtracted from the resulting data.

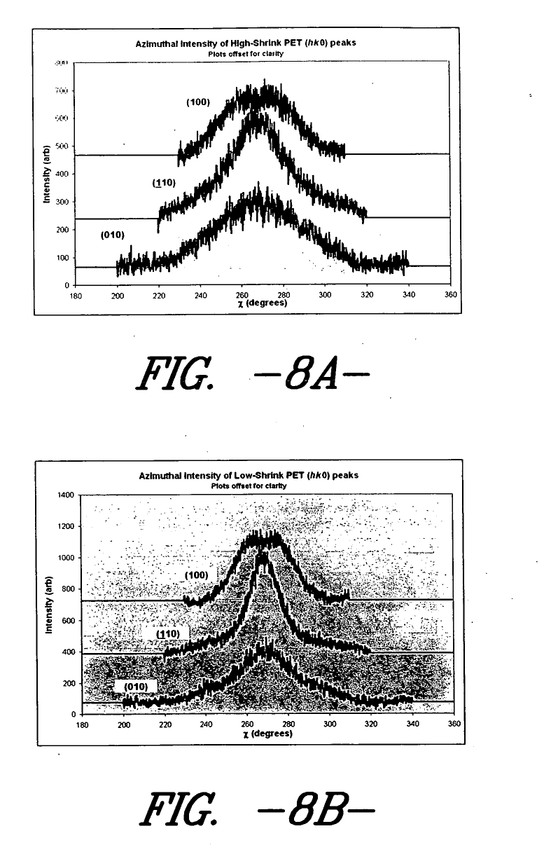

The diffraction pattern for the high-shrink yarn sample is shown in FIG. 7A and that for the low-shrink yarn is shown in FIG. 7B wherein the lighter zones identify higher reflection intensity levels. Qualitatively, it was observed that in the two patterns the crystal plane reflections (the broad intensity peaks) in the high-shrink sample have a greater azimuthal spread than those in the low-shrink sample. It is known that the two primary causes of azimuthal spreading in multifilament fiber samples are misalignment of individual filaments and differences in the angular distribution of crystallites between the samples. Great care was taken during sample preparation to properly parallelize the filaments, and a slight tension was applied to maintain good orientation during handling and measurement. Thus, it is very unlikely that filament disorientation alone can account for the differences in angular peak distribution observed in the patterns. Therefore, it was determined that the azimuthal spread reflects a real difference in the angular distribution of crystallites between the two samples.

It is known that the difference in the angular distribution of crystallites between the two samples can be quantified in terms of the Herman orientation function:

$${f}_{c} = \frac{3 〈 {cos}^{2} σ 〉 - 1}{2}$$

where a is the relative angle of the PET chain axis. As will be appreciated, the Herman orientation function is a measure of the orientation of PET chains within fiber crystallites with respect to the fiber axis direction. It assumes values ranging from +1 (perfectly oriented parallel to the axis) to 0 (perfectly random) to −½ (perfectly oriented perpendicularly). For cylindrically symmetric (on average) fibers, the distributional average of the square cosine term is given by:

$$〈 {cos}^{2} χ 〉 = \frac{{\int }_{0}^{π} {cos}^{2} χ {I}_{P} ( χ ) sin χ ⅆ χ}{{\int }_{0}^{π} {I}_{P} ( χ ) sin χ ⅆ χ} .$$

Where I_{P}(χ) is the angular distribution of a directional vector P (in this case, the PET chain direction) as measured with respect to a reference direction, in this case the fiber axis.

In PET there does not exist a crystalline reflection in the direction of the PET chains. Thus, to determine the Herman orientation function for PET chains a well recognized geometric relationship is utilized to develop the square cosine term.
<cos² σ>=1−0.8786<cos² χ₍₀₁₀₎>−0.7733<cos² χ₍₁₁₀₎>−0.3481<cos² χ₍₁₀₀₎>,
where σ is the relative angle of the PET chain axis, and χ₍ₕₖ₀₎ are the relatives angles of the (hk0) crystalline reflections. This relationship was described by Z. Wilchinsky in Journal of Applied Physics 30, 792 (1959) the contents of which are incorporated herein by reference.

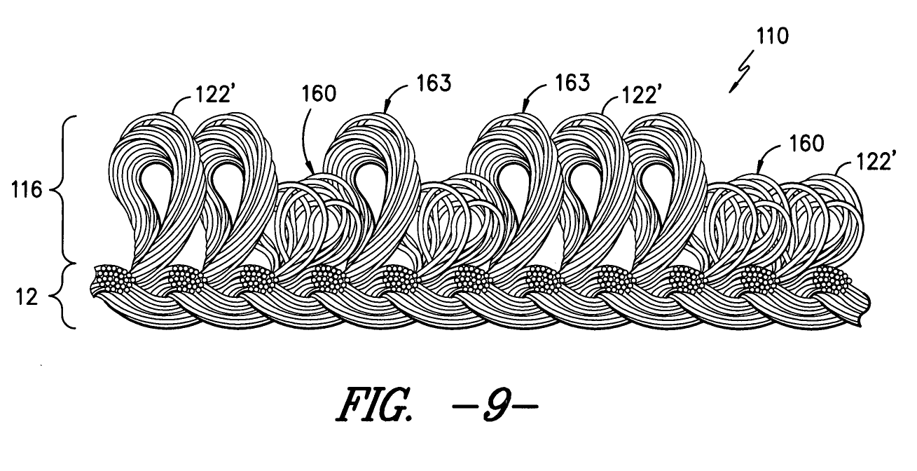

The <cos² χ₍ₕₖ₀₎> terms can be numerically computed by extracting the I₍ₕₖ₀₎(χ) distributions from the measured diffraction patterns. Angular distributions were computed by integrating the pattern signals over a 0.7° range of 2θ values centered on the following positions: 17.65° for the (010) reflection, 22.75° for the (110) reflection, and 25.35° for the (100) reflection. Distributions of x-ray peaks for the high shrink and low shrink yarn segments (used for purposes of integration) are shown in FIGS. 8A and 8B. Because of the limited detector area, distributions were extrapolated out to the full 180° range by assuming the signal at high angles was due solely to amorphous scattering. This amorphous baseline was subtracted from the distributions before numerical integration.

Results from the numerical determination of the Herman orientation function (ƒ_{c}) are shown in Table II below. As shown, the low-shrink yarn sample possesses a measurably higher level of orientation.

TABLE II

| | High Shrink | Low Shrink |
|---|---|---|
| <cos\hat{ }2(θ100)> | 0.060 | 0.038 |
| <cos\hat{ }2(θ110)> | 0.087 | 0.062 |
| <cos\hat{ }2(θ010)> | 0.108 | 0.083 |
| <cos\hat{ }2(σ)> | 0.817 | 0.866 |
| Herman fc | 0.725 | 0.799 |

In order to confirm the legitimacy of the crystalline orientation evaluations on the treated yarn of the present invention, a control analysis was conducted on a standard fully drawn 265 denier 36 filament partially oriented PET yarn that had been cold drawn with a 2.1 draw ratio and heat set at 220 C. Three samples were taken from segments 6 to 12 inches apart along the length of the yarn and x-ray patterns were generated using 45 minute exposures. An air scattering frame was also acquired and subtracted from the data before analysis. The same calculations were performed as described above. The Herman orientation function calculated based on the measurements of these samples ranged from 0.819 to 0.853 which is a difference of 0.034. This is less than half the difference of 0.074 measured for the high shrink and low shrink portions of the yarn. Thus, there exists a much greater variation in crystalline orientation between portions of the yarns of the present invention following heat treatment than in standard yarns.

Based on the evaluations carried out it may be seen that the interlaced nodes along the yarn give rise to the high shrink portions of the yarn. Moreover, upon application of heat treatment these high shrink portions shrink to a greater degree and have a lower level of crystalline orientation (as measured by the Herman Orientation Function) than the low shrink portions. Moreover, the degree of variation between high shrink and low shrink zones along the length of the yarns of the present invention is substantially greater than variations in standard yarns.

Fabric Formation:

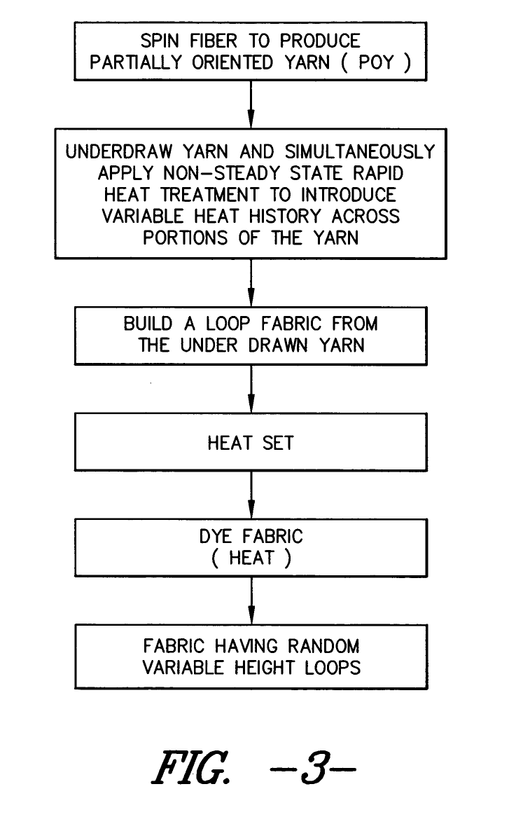

As will be appreciated through reference to FIG. 3, subsequent to the introduction of variable heat treatment across portions of the yarn to introduce the above-described variable shrinkage characteristics, the yarn 122′ may thereafter be formed into a loop fabric such as is illustrated and described in reference to FIG. 1. That is, the formed greige fabric is characterized by loop heights which are substantially uniform. However, due to the variable heat treatment history at zones along the pile-forming yarns, when the formed greige fabric is heat set and dyed at prolonged elevated temperatures, zones of the pile-forming yarn react in dramatically different fashions thereby imparting a variability to the finished fabric appearance. In particular, portions of the pile-forming yarns which made up the interlace nodes 152 and adjacent areas and which did not undergo a uniform heat treatment during drawing tend to undergo selective shrinkage during the heat setting and dyeing operations. As explained above, this shrinkage occurs as a result of the fact that the shrinkage potential within these yarn zones has not been relieved previously. Conversely, the loop portions which were in the loose portions of the yarn between the interlace nodes do not undergo substantial shrinking during the heat setting and dyeing operation since shrinkage potential has been relieved previously.

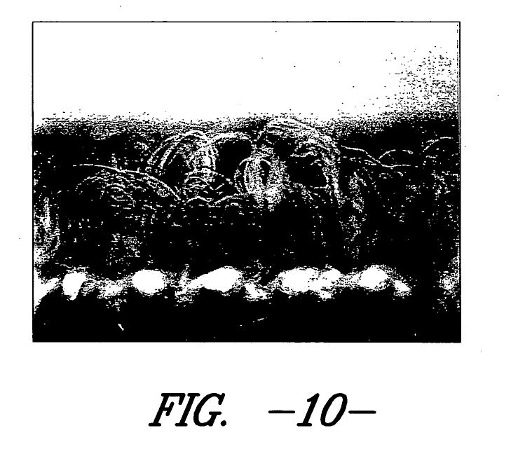

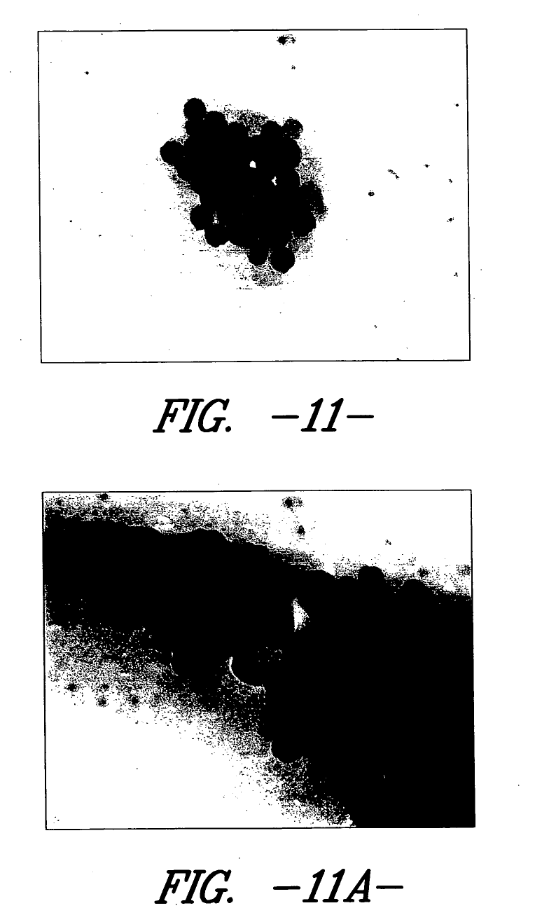

A resultant fabric structure following heat treatment and dyeing is illustrated in FIG. 9. As shown, although the same yarns 122′ are utilized throughout the pile portion 116 of the fabric 110, portions of those yarns have undergone shrinkage so as to form low profile loop segments 160 of a self-textured entangled construction across the ground fabric 112. The segments of the yarns which have undergone uniform heat treatment during the initial drying operation do not undergo such shrinkage and thus define arrangements of high profile loops 163 wherein the filaments remain substantially aligned. A photomicrograph illustrating such an exemplary fabric construction is provided at FIG. 10.

As in the individual yarn samples evaluated, due to the shrinkage of the filaments 126 at different yarn segments in the fabric, the filaments within the low profile loop segments 160 of the pile portion 116 are characterized by a substantially greater diameter than the filaments in the high profile loops 163. By way of example only, for purposes of comparison photomicrographs are provided of the filament cross sections in the high profile loops 163 (FIG. 11) as well as in the low profile loop segments (FIG. 11A). In this regard it is contemplated that in order to realize the aesthetic and tactile benefits of the variable shrinkage zones along the pile-forming yarns the filaments making up the low profile loop segments will preferably have an average diameter at least about 25 percent greater (more preferably at least about 50 percent greater) than the average diameter of the filaments forming the high profile loops. For yarns formed from filaments with non-circular cross-sections the difference between the high shrink and low shrink portions may be measured in terms of cross-sectional area. Whether yarns with circular or non-circular filaments are used, the low profile loop segments will preferably have an average cross-sectional area at least about 1.56 times (more preferably at least about 2.25 times) the average area of the filaments forming the high profile loops. In the illustrated exemplary constructions, a comparison of the filaments of FIGS. 11 and 11A shows that some of the filaments in the low profile loop segments are at least twice the diameter of some of the filaments in the high profile loops. Thus, for yarns formed from non-circular filaments it is contemplated that at least a portion of the filaments in the low profile loop segments will have a cross-sectional area 4 times the area of some filaments forming the high profile loops.

By way of example only, within a yarn 122′ according to the present invention it is contemplated that the number of interlace nodes will preferably be in the range of about 10 to 40 nodes per meter with each node taking up about 0.6 to about 1.3 cm. Thus, it is contemplated that zones of high retained shrinkage potential will preferably make up about 6% to about 52% percent of the total length of the yarn and will more preferably make up about 25% of the total length of the yarn.

As previously indicated, a substantial benefit of the present invention is that the low profile loop segments 160 of heat shrunk yarn are present across the surface of the fabric in a substantially random arrangement. This imparts a substantially natural random look which may be desirable in many instances. Moreover, since the low profile zones undergo heat shrinkage as a result of activating intrinsic heat shrink potential, such shrinkage occurs without embrittlement and results in a self crimping of the yarns in the low profile zones which emulates texturing thereby enhancing a soft feel and avoiding filament breakage leading to undesirable shredding. In this regard it is to be understood that the terms “self textured” or “self crimping” refers to the characteristic that the filaments have a crimped construction after shinkage without the application of external crimping or texturizing procedures. As previously indicated, after self-texturing takes place, the high shrink portions of the yarn have a lower level of crystalline orientation than the low shink portions. In this regard it is contemplated that the level of crystalline orientation of the low shrink portions of the yarn as measured by the Herman Orientation Function will on average be at least 5% greater (and more preferably at least 10% greater) than the level of crystalline orientation of the high shrink portions.

The invention may be further understood through reference to the following non-limiting example.

### EXAMPLE

A 115 denier 36 filament semi-dull round partially oriented polyester yarn was subjected to a 1.143 draw across a contact Dowtherm heater plate operated at a temperature of 170 C. The heater contact length was 17 inches and the yarn was taken up off of the heater at a rate of 600 yards per minute. The yarns were spaced at a density of approximately 17.4 yarns per inch across the heater. The warper tension was set at 26 to 30 grams. Overall draw ratio was 1.165. Measurements of the post drawn yarn indicated a linear density of 103.6 denier, a boiling water shrinkage of 11.16%, an elongation of 87.46% and a breaking strength of 267 grams. The drawn yarn was knitted into the face of a 2 bar 56 gauge POL knit fabric with the ground being formed of a single ply 150 denier 36 filament semi-dull round false twist textured polyester. The bar 1 (face yarn) runner length was 136 inches. The bar 2 (ground yarn) runner length was 55 inches. The knitting machine was fully threaded. The resultant fabric had 66 coarses per inch with a pile height of 0.065 inches and a width of 57.25 inches. Samples of the resultant greige fabric were thereafter subjected to heat setting at 330° F. and at 410° F. No difference in the finished fabrics was observed. The fabric heat treated at 330° F. was thereafter subjected to hot air jet application at 625° F. The fabrics were jet dyed at 266° F., held for 30 minutes with a 20 F per minute temperature ramp up. The fabrics were wet pad tenter dried at a temperature of 250° F. passing through the tenter at 25 yards per minute. The exit width after drying was 56 inches. The resultant fabric had random high loops with relatively greater oriented crystalline regions than the low loops which were characterized by very low order orientation of the crystals as measured by wide angle X-ray scattering.

1. A loop pile fabric comprising a base portion and a pile portion, wherein the pile portion comprises a first group of yarn loops projecting outwardly from the base portion to a first height and at least a second group of yarn loops projecting outwardly from the base portion to a second height lower than the first height, wherein at least a portion of the first group of yarn loops and at least a portion of the second group of yarn loops are formed from segments of a common yarn and wherein in the fabric the segments of the common yarn forming the second group of yarn loops comprise a plurality of yarn filaments characterized by an average cross-sectional area at least 1.56 times the average cross-sectional area of yarn filaments in the segments of the common yarn forming the first group of yarn loops.

2. The invention as recited in claim 1, wherein the loop pile fabric is a knit fabric.

3. The invention as recited in claim 2, wherein the loop pile fabric is a POL knit fabric.

4. The invention as recited in claim 2, wherein the loop pile fabric is a Tricot knit fabric.

5. The invention as recited in claim 2, wherein the loop pile fabric is a Raschel knit fabric.

6. The invention as recited in claim 1, wherein the common yarn is a multi-filament polyester yarn.

7. The invention as recited in claim 1, wherein the common yarn is a multi-filament polypropylene yarn.

8. The invention as recited in claim 1, wherein the common yarn is a multi-filament nylon yarn.

9. The invention as recited in claim 1, wherein the segments of the common yarn forming the second group of yarn loops comprise a plurality of yarn filaments having a lower degree of crystalline orientation than the yarn filaments in the segments of the common yarn forming the first group of yarn loops such that the average level of crystalline orientation of yarn filaments in the segments of the common yarn forming the first group of yarn loops as measured by the Herman Orientation Function is at least 5% greater than the average level of crystalline orientation of the yarn filaments in the segments of the common yarn forming the second group of yarn loops.

10. The invention as recited in claim 1, wherein the segments of the common yarn forming the second group of yarn loops are characterized by a substantially non-parallel arrangement of crimped yarn filaments.

11. The invention as recited in claim 1, wherein the segments of the common yarn forming the second group of yarn loops comprise a plurality of substantially circular cross-section yarn filaments characterized by an average cross sectional diameter which is at least 50 percent greater than the average cross sectional diameter of yarn filaments in the segments of the common yarn forming the first group of yarn loops.

12. The invention as recited in claim 1 1, wherein at least a portion of the yarn filaments in the segments of the common yarn forming the second group of yarn loops are characterized by a cross sectional diameter which is at least twice the cross sectional diameter of one or more yarn filaments in the segments of the common yarn forming the first group of yarn loops.

13. A loop pile fabric comprising a base portion and a pile portion, wherein the pile portion comprises a first group of yarn loops projecting outwardly from the base portion to a first height and at least a second group of yarn loops projecting outwardly from the base portion to a second height lower than the first height, wherein at least a portion of the first group of yarn loops and at least a portion of the second group of yarn loops are formed from segments of a common yarn and wherein in the fabric the segments of the common yarn forming the second group of yarn loops comprise a plurality of yarn filaments characterized by an average cross-sectional area which is at least 1.56 times the average cross sectional diameter of yarn filaments in the segments of the common yarn forming the first group of yarn loops and wherein the yarn filaments in the segments of the common yarn forming the second group of yarn loops are characterized by a lower degree of crystalline orientation than the yarn filaments in the segments of the common yarn forming the first group of yarn loops such that the average level of crystalline orientation of yarn filaments in the segments of the common yarn forming the first group of yarn loops as measured by the Herman Orientation Function is at least 5% greater than the average level of crystalline orientation of the yarn filaments in the segments of the common yarn forming the second group of yarn loops.

14. The invention as recited in claim 13, wherein the common yarn is a multi-filament polyester yarn.

15. The invention as recited in claim 14, wherein the average level of crystalline orientation of yarn filaments in the segments of the common yarn forming the first group of yarn loops as measured by the Herman Orientation Function is at least 10% greater than the average level of crystalline orientation of the yarn filaments in the segments of the common yarn forming the second group of yarn loops.

16. The invention as recited in claim 13, wherein the segments of the common yarn forming the second group of yarn loops are characterized by a substantially non-parallel arrangement of crimped yarn filaments.

17. The invention as recited in claim 16, wherein at least a portion of the yarn filaments in the segments of the common yarn forming the second group of yarn loops are substantially circular cross-sectional filaments characterized by a cross sectional diameter which is at least twice the cross sectional diameter of one or more yarn filaments in the segments of the common yarn forming the first group of yarn loops.

18. A method of forming a loop pile fabric comprising a base portion and a pile portion, wherein the pile portion comprises a first group of yarn loops projecting outwardly from the base portion to a first height and at least a second group of yarn loops projecting outwardly from the base portion to a second height lower than the first height, the method comprising the steps of:
underdrawing a partially oriented multi-filament yarn across a heat source at a rate such that portions of the yarn undergo substantially complete heat setting and other portions do not undergo substantially complete heat setting;
forming the yarn into the pile portion of the loop pile fabric; and
heating the fabric such that portions of the yarn which did not undergo substantially complete heat setting during the underdrawing step shrink towards the base portion of the fabric in a crimped self texturing manner.
